(19) United States
(12) Patent Application Publication
(10) Pub. No.: US 2005/0072328 A1
(43) Pub. Date: Apr. 7, 2005

(54) Automated system to control printing contact pressure

(76) Inventors: Ronald D. Gilliam, Oberlin, OH (US); Patrick Gilliland, Burton, OH (US)

Correspondence Address: John F. McDevitt;# 626, 2255 Par Lane, Willoughby Hills, OH, 44094, US

(21) Appl. No.: 10/952,332

(22) Filed: Sep. 28, 2004

Related U.S. Application Data
(60) Provisional application No. 60/508,498, filed on Oct. 3, 2003.

(51) Int. Cl. B41F 13/24

(52) U.S. Cl. 101/247; 101/484

(57) ABSTRACT

A fully automated system is disclosed to control the contact pressure being exerted to form a visual image in a rotary type printing press. The control system continuously measures the contact pressure when the press printing plates are in registration and generates an electrical feedback signal to automatedly control the contact pressure during continued press operation.

### RELATED PROVISIONAL APPLICATION

This application relates to Provisional Application Ser. No. 60/508,498 filed by the present applicants on Oct. 3, 2003.

### BACKGROUND OF THE INVENTION

This invention relates generally to a method and apparatus for automated regulation of the contact pressure being exerted when the printed image is being formed in a rotary type printing press and more particularly to providing a novel automated control system in doing so for any corrective action needed.

The contact pressure being exerted between rotating printing plates during operation of a rotary printing press, such as an offset press, a lithograph press and the like, is well recognized to undergo significant variation reducing the quality of the printed image. For example, too little contact pressure results in a printed image being faint or missing details and which can require further press operation for avoidance of additional spoilage. Such corrective action taken by the press operator can understandably be carried out long after needed thereby causing considerable loss of the various objects on which the printed image is applied, such as metal cans, plastic containers and the like. In a similar manner, the application of excessive contact pressure when the printed image is being applied causes the liquid ink to smear upon deposition and thereby require the press operator to make the necessary adjustments for reducing the amount of this operating factor during continued press operation. Such variation in contact pressure between the printing plates during operation of a rotary printing press can also be caused by a wide variety of operating conditions, including temperature changes, rotational speeds of operation, materials employed to produce the printed image and still other operating factors. A commonly experienced temperature change affecting contact pressure between the rotating printing plates occurs during press start-up after customary periods of press inactivity which causes critical printing surfaces to avoid physical contact due to experiencing lower temperatures while being inactive. It remains desirable, therefore, to provide improved means whereby the printing contact pressure in a rotary printing press can be more effectively controlled during press operation.

In my recently issued U.S. Pat. No. 6,543,350B2, there is disclosed a measurement system enabling the operator of a rotary printing press to continuously discern the contact pressure being exerted during press operation. Said measurement system require the pressure sensing components being employed to cooperate with further sensing components detecting angular position of the printing plates when the pressure measurements are being carried out to produce a continuous visual display for the press operator. An automated control system to regulate the contact pressure during rotary type press operation is also disclosed in U.S. Pat. No. 5,275,099 wherein automated roller adjustment is carried out. In doing so, the contact pressure between a rotating plate roller and a form roller physically abutting said rotating plate roller is detected with multiple strain gage sensors mounted on a mechanical pivot arm. Continued correction of the contact pressure during press operation to a predetermined or preestablished contact pressure value is said to be achieved automatically with a feedback type servomechanism employing comparator means.

To overcome the difficulties experienced with manual contact pressure adjustment as well as automated control of the printing contact pressure by said prior art regulation means, there is now provided a novel fully automated system to regulate visual image formation in a rotary type printing press by still further improved means. In the present control method, the actual contact pressure between pairs of operationally cooperating printing plates in an offset type rotary printing press is controlled by novel means. In doing so, the apparatus continually senses when a first printing plate disposed on the outer surface of the rotating plate roller comes into registration with a second printing plate disposed on the outer surface of the rotating blanket roller and concurrently measures the dynamic contact pressure being exerted between said rotating printing plates while remaining in registration. Said measured contact pressure values are next compared with preestablished contact pressure values to generate an electrical feedback control signal which is applied to conventional programmed controller means for fully automated control of the actual printing plate contact pressure during continued press operation. A more direct control of said dynamic printing plate contact pressure in this manner can understandably improve the operating efficiency of various type rotary printing presses to include those having single and multiple printing heads as well as those producing single and multicolored printed images.

It is an object of the present invention, therefore, to provide an automated control system for operation of a rotary printing press to improve the visual quality of the printed image.

It is another object of the present invention to provide such presently improved actual printing plate contact pressure in a manner requiring only a relatively simple modification to the existing rotary printing press apparatus.

A still further object of the present invention is to provide a rotary printing press incorporating the presently improved control system for increased operating efficiency.

It is yet another object of the present invention to provide a novel method for automated control of a rotary printing press to increase the quality of the printed image.

These and still further objects of the present invention will become more apparent upon considering the following more detailed description of the present invention.

### SUMMARY OF THE INVENTION

It has now been discovered by the present applicants that the printed image quality produced in a rotary type printing press can be significantly improved with novel fully automated control means. Generally, the presently improved control system is incorporated in a rotary printing press having pairs of rotating printing plates disposed on the outer surface of rotating plate and blanket rollers and which further includes a pair of upper and lower form rollers transferring ink to the printing plates disposed on said plate roller. The present automated control method first senses during press operation when the printing plates disposed on the plate and blanket rollers come into registration and continuously measures the contact pressure being exerted between the plate and blanket rollers during the time period when the physically contacting printing plates remain in registration, next determines the difference between the measured contact pressures and preestablished contact pressure values to generate an electrical feedback control signal, and employs said electrical feedback control signal to automatedly vary the contact pressure between the plate and blanket rollers during continued press operation. Since the present fully automated control system can be utilized with the particular type rotary press apparatus described in the aforementioned U.S. Pat. No. 6,543,350B2, the entire contents of said issued patent are incorporated herein by reference. In accordance therewith, many of the same position and contact pressure sensing devices can be employed in the present control system in order to generate the now further required electrical feedback control signal. Registration between the paired printing plates on the plate and blanket rollers in the present control system can thereby employ the same proximity or position sensing devices disclosed in the referenced patent. Likewise, the same previously disclosed pressure sensing devices, such as strain gages and the like, can be employed in the present control system for the contact pressure measurements. Both of said type sensing devices cooperate in a particular manner for development of the further required electrical feedback control signal in the present control system. More particularly, said electrical feedback control signal is produced with programmed electrical controller means that operates upon these measured values.

In a representative embodiment, a Microstar Model DAP1200a controller device is employed for closed loop control of the printing plate contact pressure although still other commercially available controller devices of the proportional/integral/derivative type (PID) are considered equally suitable. The programmed sequence of operations for said controller in the present control system is initiated by the position sensing devices indicating when the paired printing plates come into registration. Contact pressure measurements from the pressure sensing devices are then continuously applied to the controller device during the time period when the paired printing plates remain in registration. In doing so, the analog strain gage values are converted to digital signals for input to said controller. Said applied force measurements are then averaged in the controller for comparison with preestablished contact pressure values previously entered by the press operator and with any difference detected therebetween forming an error signal which is further applied to corrective pressure adjustment means included in the present apparatus. Any needed contact pressure adjustment with the present control system is thereby carried out automatically in the press apparatus by adjusting the contact pressure being exerted between the form rollers and the plate roller. Having customary electric stepper motor and gear box arrangements or the like which are physically secured to the press frame for said purpose have already proven acceptable. Any change needed to meet said preestablished contact pressure values in said manner will be provided by the number of steps and direction of the stepper motor device when actuated by the output error signal from the operatively associated controller device. Such operational control can be further carried out by employing individual stepper motor and gearbox arrangements to adjust each form roller in the press apparatus.

### BRIEF DESCRIPTION OF THE DRAWINGS

FIG. 1 is a schematic side view for a representative multiple printing head rotary printing press according to the present invention.

FIG. 2 is a side view depicting the physical mounting of a strain gage sensor in the FIG. 1 rotary printing press.

FIG. 3 is a representative flowchart illustrating typical PID controller operation in the present automated control system.

### DETAILED DESCRIPTION OF THE PREFERRED EMBODIMENTS

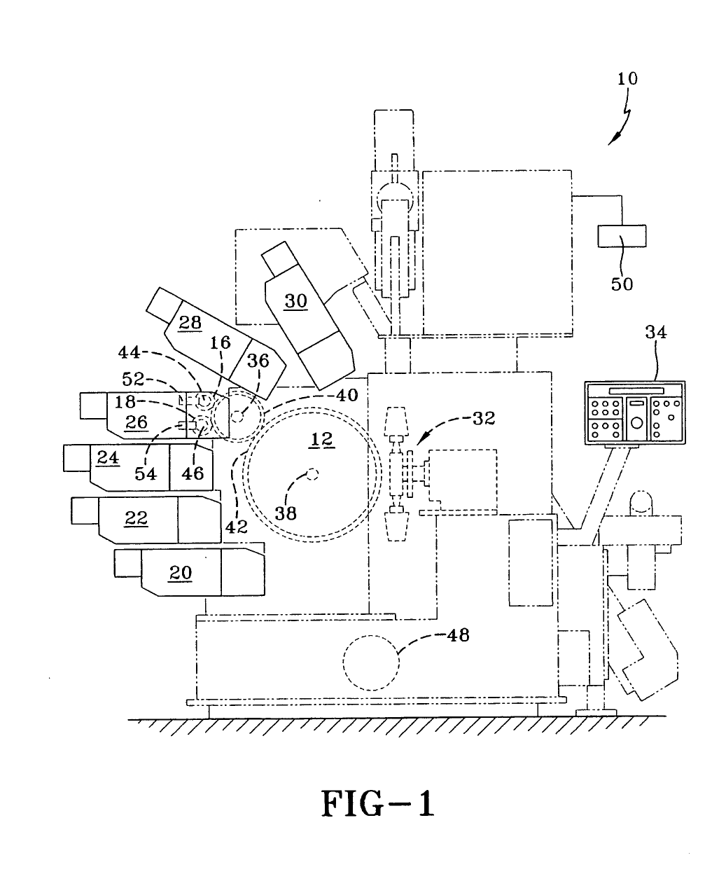

Referring to the drawings, there is shown in FIG. 1 a schematic side view of a conventional offset printing press which incorporates a representative automated control system of the present invention. Basically, the depicted rotary printing press 10 includes blanket roller 12, plate roller 14, a pair of upper and lower form rollers 16 and 18, respectively, physically engaging plate roller 14, multiple printing heads 20-30, a rotating turret-type feed mechanism 32 for the product articles (not shown) on which a multi-colored printed image is applied and a commercial proportional/integral/derivative (PID) controller device 34 enabling fully automated control of printing plate contact pressure during press operation. The further depicted components of the illustrated control system comprise conventional proximity or position sensors 36 and 38 physically connected to both plate and blanket rollers, respectively, to determine when a pair of printing plates 40 and 42 physically disposed on the peripheral surface of both plate and blanket rollers (12 and 14) come into registration, strain gages 44 and 46 operationally connected to form rollers 16 and 18, a conventional data processor 50 for converting the analog electrical signals from both strain gages to digital signals, and a pair of electrical stepper motor arrangements 52 and 54 individually adjusting both form rollers. In this manner, the proximity sensor for the plate roller detects the leading edge of a first plate disposed thereon. When the proximity sensor for the blanket roller indicates that a second printing plate disposed thereon rotates in registration with said first printing plate then the measurement of the contact pressure being exerted between said printing plates is initiated for input to the operationally associated controller device being employed in the present control system. Suitable proximity or position sensor devices for use in the illustrated control system include Model PMF-44 manufactured by Sunx, West DesMoines, Iowa and Model OG5054 manufactured by Effector Corporation, Exton, Pa.

FIG. 2 is a side view depicting one of the pivoting mechanical arms 60 to which individual strain gages in the FIG. 1 automated control system are physically secured. Each of said L shaped mechanical arms pivots about a shaft 62 with end portion 64 being fixed to the printing press frame (not shown) whereas free end portion 66 is attached to the shaft 58 on which each from roller (16 and 18) rotates. Accordingly, said multiple mechanical arms are individually disposed at opposite ends of both upper and lower form rollers in the presently illustrated control system thereby enabling the printing contact pressure to be continuously measured over much of the printing surface while the printing plates on the plate and blanket rollers remain in registration. As can be further noted in the present drawing, free end portion 66 of the pivoting mechanical arm includes a cavity 70 in which an individual strain gage (44 and 46) resides with air gaps or discontinuities 72 and 74 having been formed on each side of said cavity to increase the sensitivity of the printing contact pressure measurements when made. Understandably, a measurement of the printing contact pressure in the described manner further serves to improve printing quality in all major spatial directions.

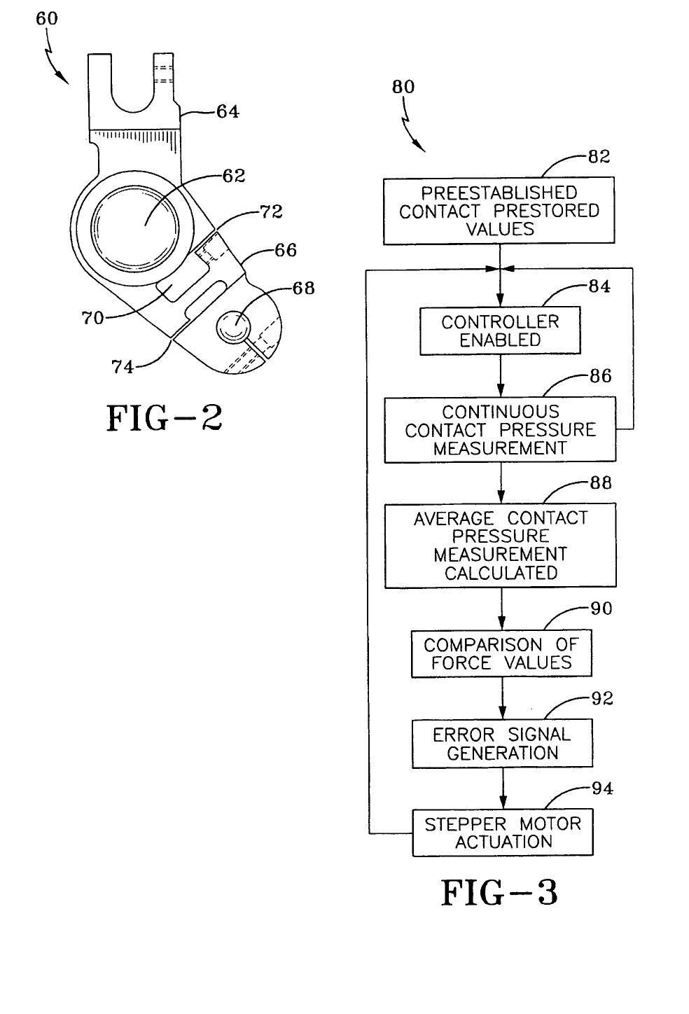

There is depicted in FIG. 3 a representative flowchart further illustrating the automated control procedure being employed in the FIG. 1 apparatus. As a first step in the present control method, preestablished printing plate contact pressure values are entered by the press operator into PID controller device 34 for subsequent comparison with the measured contact pressure values. Such controller device is next enabled for operation when proximity sensors 36 and 38 detect a registration between printing plates 40 and 42 in the apparatus. Continuous contact pressure measurements from strain gages 44 and 46 are thereupon supplied to said controller device for calculation of an average contact force value while the pair of printing plates remain in registration. The controller device then averages the measured contact pressure values for comparison with the previously entered preestablished contact pressure values and generates an electrical feedback control signal for any differences found between the compared values. More particularly, if the measured force values deviate from the preestablished force values entered by the press operator then a conventional control algorithm in the controller device determines the amount of force change needed to effect correspondence between the compared force values. Any needed force change indicated with such comparison is transmitted to both stepper motor devices with said control signal while further being fed back to the controller device for continuous contact pressure adjustment. The flowchart 80 in FIG. 3 further depicts the sequence of these method steps providing closed loop control of printing contact pressure according to the present invention. Step 82 reflects operator entry of a force set-point into the controller device. Said controller becomes enabled in step 84 upon indication from the operationally associated position sensing devices that a pair of rotating printing plates on the plate and blanket rollers have come into registration. Continuous contact pressure measurements are thereupon conducted in step 86 during the entire time period when the paired printing plates remain in registration. Such continuous measurement of the contact force being applied enables updating of the measured force values being accumulated in said controller device. Step 88 next calculates the average value of said measured contact pressure values in the operating controller device. In next step 90 the average measured contact pressure values are compared with the operator set-point values to determine any differences found between said values. Any differences detected in said controller device between the compared force values next generates an output feedback control signal to the further operationally associated stepper motor devices for any needed force changes in step 92. In final step 94 of said closed loop control system the amount of any force change needed is carried out by the number of steps and direction taken by stepper motor operation as determined with said feedback control signal.

It will be apparent from the foregoing description that a broadly useful and novel means has been provided to continuously control the contact pressure being exerted when the actual printed image is being formed in a rotary printing press. It is contemplated that various modifications can be made in the present method for controlling print quality as well as the apparatus means being employed to do so other than herein specifically illustrated, however, without departing from the spirit and scope of the present invention. For example, other position sensors denoting proper registration between the rotating printing plates on the plate and blanket rollers can be employed as well as substituting other pressure sensing devices than mechanical strain gages. Similarly, other data processors and controller devices are contemplated for use in the present closed loop control procedure than herein illustrated for even more extensive control of the printing contact pressure leading to still further improved print quality. Accordingly, it is intended to limit the present invention only by the scope of the appended claims.

1. An automated method to control contact pressure between pairs of rotating printing plates disposed on the outer surface of rotating plate and blanket rollers of an offset type rotary printing press further including a pair of upper and lower form rollers physically abutting said plate roller which comprises:
(a) sensing during press operation with said rotating plate and blanket rollers when a first printing plate disposed on the outer surface of said rotating plate roller comes into registration with second printing plate disposed on the outer surface of said rotating blanket roller,
(b) concurrently and continuously measuring the contact pressure being exerted between said pair of rotating form rollers and said rotating plate roller during the time period when the printing plates on the plate roller and blanket roller remain in registration,
(c) determining the difference between the measured contact pressure values and preestablished contact pressure values to generate an electrical feedback control signal, and
(d) employing said electrical feedback control signal to automatedly vary the measured contact pressure by said pair of rotating form rollers during continued press operation.

2. The method of claim 1 wherein the contact pressure is measured with a mechanical pressure sensing device.

3. The method of claim 2 wherein said mechanical pressure sensing device is disposed at the end of said form rollers.

4. The method of claim 1 wherein registration between the printing plates on the plate and blanket rollers is detected with a position sensing device.

5. The method of claim 1 wherein the electrical feedback control signal is generated with a programmed electrical proportional/integral/derivative controller device.

6. The method of claim 1 wherein the printed image formed in said manner has multiple colors.

7. The method of claim 6 wherein the multiple colors are all applied during a single rotation of the blanket roller.

8. The method of claim 1 wherein varying the contact pressure between said pair of rotating form rollers and the rotating plate roller is conducted with stepper motor means operationally connected to said form rollers.

9. The method of claim 4 wherein registration between the printing plates on the plate and blanket rollers is detected with multiple sensing devices.

10. The method of claim 9 wherein the sensing devices detect when the leading edge of the paired printing plates come into registration.

11. The method of claim 1 wherein the contact pressure values are determined with a strain gage device.

12. The method of claim 11 wherein said strain gage device generates an output voltage signal.

13. A fully automated method to control contact pressure between pairs of rotating printing plates disposed on the outer surface of rotating plate and blanket rollers of an offset type rotary printing press further including a pair of upper and lower form rollers physically abutting said plate roller which comprises:
(a) continuously sensing during press operation with position sensing devices disposed on both plate and blanket rollers when a first printing plate disposed on the outer surface of said rotating plate roller in said printing press comes into registration with a second printing plate on the outer surface of said blanket roller in said printing press,
(b) concurrently and continuously measuring the contact pressure being exerted between said pair of rotating form rollers and the rotating plate roller during the time period when the printing plates on the plate and blanket rollers remain in registration, said contact pressure being measured with strain gage devices which are disposed adjacent opposite ends of both upper and lower form rollers,
(c) continuously determining the difference between the measured contact pressure values and preestablished contact pressure values in a programmed electrical proportional/integral/derivative controller device to generate an electrical feedback control signal which is fed back to said controller device, and
(d) applying the output electrical signal from said controller device to electrical stepper motor means to automatedly regulate the measured contact pressure.

14. A measurement system to automatedly control the operating contact pressure between pairs of rotating printing plates disposed on the outer surface of rotating plate and blanket rollers in an offset type printing press further including a pair of upper and lower form rollers physically abutting said plate roller which comprises:
(a) position sensing means to continuously detect during press operation when a first printing plate disposed on the outer surface of said rotating plate roller comes into registration with a second printing plate disposed on the outer surface of said blanket roller,
(b) pressure sensing means to measure the contact pressure being exerted between said pair of form rollers and the rotating plate roller during the time period when the printing plates on the plate roller and blanket roller remain in registration, and
(c) programmed electrical controller means determining the difference between the measured contact pressure values and preestablished contact pressure values to generate an electrical feedback control signal which automatedly varies the measured contact pressure during continued press operation.

15. The measurement system of claim 14 wherein the programmed electrical controller means includes an electrical proportional/integral/derivative controller device.

16. The measurement system of claim 15 wherein the feedback control signal is fed back to said controller device.

17. The measurement system of claim 14 wherein varying the measured contact pressure is conducted with stepper motor means operationally connected to said form rollers.

18. An offset type rotary printing press having at least one pair of printing plates disposed on the outer surface of rotating plate and blanket rollers which come into registration during press operation, a print head assembly which includes a pair of upper and lower form rollers physically abutting said plate roller, and control means to automatedly vary the operating contact pressure between said pair of printing plates during printing plate registration which comprises:
(a) position sensing means disposed in said printing press to continuously detect during press operation when a first printing plate disposed on the outer surface of said rotating plate rollers comes into registration with a second printing plate disposed on the outer surface of said blanket roller,
(b) pressure sensing means disposed in said print head assembly and connected to both form rollers to measure the contact pressure being exerted between said pair of form rollers and the rotating plate roller during that time period when said pair of printing plates on the plate and blanket rollers remain in registration,
(c) electric motor driven means disposed in said print head assembly and also connected to both form rollers for any needed contact pressure adjustment between said pair of rotating printing plates during registration, and
(d) programmed electrical controller means operationally connected to said printing head assembly determining any differences found between the measured contact pressure values and preestablished contact pressure values to generate an electrical feedback control signal which automatedly varies measured contact pressure during continued press operation.
